(19) United States
(12) Patent Application Publication
(10) Pub. No.: US 2011/0153294 A1
(43) Pub. Date: Jun. 23, 2011

(54) METHOD OF THREE DIMENSIONAL RAY TRACING IN THE DYNAMIC RADIO WAVE PROPAGATION ENVIRONMENT

(75) Inventors: Young-keun Yoon, Chungcheongbuk-do (KR); Heon-jin Hong, Daejeon-si (KR)

(73) Assignee: ELECTRONICS AND TELECOMMUNICATIONS RESEARCH INSTITUTE, Daejeon-si (KR)

(21) Appl. No.: 12/743,603

(22) PCT Filed: Apr. 6, 2009
(86) PCT No.: PCT/KR2009/001760

§ 371 Date: May 19, 2010

(30) Foreign Application Priority Data
Jul. 23, 2008 (KR) 10-2008-0071680

(51) Int. Cl. G06G 7/48

(52) U.S. Cl. 703/6

(57) ABSTRACT

Disclosed is a three dimensional ray tracing method in a dynamic radio wave propagation environment. The method of tracing three dimensional ray in a dynamic radio wave propagation environment, by which cross tests are performed on a plurality of radio wave blocking obstacle surfaces according to a ray tube tracing scheme based on an image method in a simulation area, in which the plurality of radio wave blocking obstacle surfaces are modeled, to detect a radio path between a first point and a second point, the method comprising: defining at least a part of the radio wave blocking obstacle surfaces as valid radio wave blocking obstacle surfaces, the radio wave blocking obstacle surfaces being within a visible region from the first point of which location varies dynamically; and tracing a ray between the first point and the second point by taking into consideration only the defined valid radio wave blocking obstacle surfaces to be simulated. Accordingly, even when both locations of a transmission point and a receipt point vary, a three dimensional ray tracing for radio wave propagation prediction is possible and simulation efficiency can be maintained.

### TECHNICAL FIELD

The present invention relates to three dimensional ray tracing for radio wave propagation prediction, and more particularly, to ray tracing by use of a ray tube based on an image method.

### BACKGROUND ART

The importance of radio wave propagation prediction has been increasingly emphasized particularly in a city area which has an amount of radio wave blocking obstacles. A ray tube tracing method based on an image method is one of methods for radio wave propagation prediction. The image method obtains image points on all surfaces of each of radio wave blocking obstacles (e.g. buildings, radio wave scattering terrain features, etc.), which may reflect rays radiated from a transmission point, receives a signal from each image point, and calculates the received signal using a receipt point to measure a received power. By combining the image method with a ray tube scheme, a ray tube tracing method based on an image method is obtained to measure a received power of a radio wave propagation path. Rays radiated from a transmission point pass through a ray tube. A path of a ray travelling between a transmission point and a receipt point is sequentially traced by use of a tree structure having a connection between nodes of reflection or diffraction on a radio wave blocking obstacle surface.

In such conventional ray tube tracing method, it is prerequisite that a transmission point is fixed and a receipt point is also fixedly located. Additionally, once a receipt point is determined in relation to a transmission point, a cross test (to check whether there is a radio wave obstacle) is performed on each of the whole nodes inside a tree structure, and if the node passes the cross test, a path to the upmost node is generated along the tree structure to detect a path between the transmission point and the receipt point. Then, an electric field of the corresponding path is calculated. However, since the conventional ray tube tracing method is based on midpoint approximation for a path, the path is detected simply by using only a receipt point and nodes of a tree structure and thus it may occur that paths which do not exist in real are included for the calculation (reflection expansion error) or existing paths are neglected from the calculation (reflection shrinkage error). Especially, in an indoor environment, path errors increase error rate.

FIG. 1 is an illustration for explaining a reflection shrinkage error.

When a second patch that is a surface of a radio wave blocking obstacle is viewed from a transmission point, a midpoint of the second patch is not seen behind a first patch, and thus a reflection ray tube is not generated on the second patch. In other words, a tree node connecting the transmission point and the second patch is not generated. In practice, a receipt point located in a first region can receive rays radiated from the transmission point, and hence a reflection ray tube node should be generated. However, since it is determined that there is no midpoint as a result of calculation and a node is not generated, the first region is neglected from the electric field calculation. This is referred to as a reflection shrinkage error. In other words, a reflection shrinkage error is neglect of reflection on a part of a patch due to a midpoint of a patch which is covered and thus is not seen.

FIG. 2 is an illustration for explaining a reflection expansion error.

When a second patch is viewed from a transmission point, since a midpoint of the second patch is seen, a reflection ray tube is generated on the second patch. That is, a tree node connecting the transmission point and the second patch is generated. The whole area (a first region and a second region) of the second patch extending from an image point of the transmission point is determined as an area to be affected by a reflection ray tube as a result of the calculation. However, in practice, only the second region is affected by the reflection ray tube. Hence, since the first receipt point is placed in the second region, the first receipt point can receive a ray reflected by the second patch, but since the second receipt point is located in the first region, the second receipt point cannot receive a ray reflected by the second patch. Nevertheless, the calculation result shows that both the first and second regions are ready for receiving. This is referred to as a reflection expansion error. In other words, a reflection expansion error is an error which determines that reflection takes place on the whole patch due to the exposure of the midpoint of the patch, while the reflection occurs only on a part of the patch in practice.

One of considerable factors of a three dimensional ray tracing method is simulation time. As the number of radio wave blocking obstacles is increasing, the number of times of calculation for ray tracing increases as well. Consequently, the simulation speed is significantly slowed down. To overcome such drawback of the simulation speed reduction, preprocessing is performed. In the preprocessing, inconsiderable radio wave blocking obstacles are detected according to predetermined conditions and discarded from a list of objects to be simulated. However, if the positions of at least one of a transmission point and a receipt point dynamically vary, the simulation time cannot be reduced with only the preprocessing. This is because a radio wave propagation path will vary when the transmission point and a receipt point dynamically change. As the result, the number of times of calculation for ray tracing will greatly increase, which will lead to a multiple increase in simulation time and a loss of simulation efficiency.

### DISCLOSURE OF INVENTION

### Technical Problem

Accordingly, the present invention provides a three dimensional ray tracing method which takes into consideration a dynamic radio wave propagation environment without increase in simulation time.

The present invention provides a three dimensional ray tracing method which reduces reflection expansion errors.

The present invention provides a three dimensional ray tracing method which reduces reflection shrinkage errors.

### Technical Solution

The present invention provides a method of tracing a three dimensional ray in a dynamic wave propagation environment, by which cross tests are performed on a plurality of radio wave blocking obstacle surfaces according to a ray tube tracing scheme based on an image method in a simulation area, in which the plurality of radio wave blocking obstacle surfaces are modeled, to detect a radio path between a transmission point and a receipt point, the method comprising: defining at least a part of the radio wave blocking obstacle surfaces as valid radio wave blocking obstacle surfaces, the radio wave blocking obstacle surfaces being within a visible region from the transmission point of which location varies dynamically; defining at least a part of the radio wave blocking obstacle surfaces as valid radio wave blocking obstacle surfaces, the radio wave blocking obstacle surfaces being within a visible region from the receipt point of which location varies dynamically; tracing a ray between the transmission point and the receipt point by taking into consideration only the defined valid radio wave blocking obstacle surfaces to be simulated.

The defining of at least the part of the radio wave blocking obstacle surfaces within a visible region from the transmission point as the valid radio wave blocking obstacle surfaces may include establishing a visible region starting from the transmission point and defining the radio wave blocking obstacle surfaces within a predetermined angle from the transmission point in the visible region as valid radio wave blocking obstacle surfaces.

In the defining of the part of the radio wave blocking obstacle surfaces within the predetermined angle from the transmission point as the valid radio wave blocking obstacle surfaces, the radio wave blocking obstacle surfaces within a corresponding beam width may be defined as the valid radio wave blocking obstacle surfaces according to an antenna pattern characteristic at the transmission point.

The defining of at least the part of the radio wave blocking obstacle surfaces within a visible region from the receipt point as the valid radio wave blocking obstacle surfaces may include establishing a visible region starting from the receipt point and defining the radio wave blocking obstacle surfaces within a predetermined angle from the receipt point in the visible region as valid radio wave blocking obstacle surfaces.

In the defining of the part of the radio wave blocking obstacle surfaces within the predetermined angle from the receipt point as the valid radio wave blocking obstacle surfaces, the radio wave blocking obstacle surfaces within a corresponding beam width may be defined as the valid radio wave blocking obstacle surfaces according to an antenna pattern characteristic at the receipt point.

The tracking of the ray may include checking whether a line connecting the transmission point to an end of the valid radio wave blocking obstacle surface crosses another radio wave blocking obstacle surface, designating an area around a midpoint of the radio wave blocking obstacle surface crossing the end of the valid radio wave blocking obstacle surface and an cross point as an interest area, performing a cross test on each of a plurality of segments forming the designated interest area to check whether the line from the transmission point crosses a normal vector of a segment midpoint, and generating a reflection ray tube for the segments which are determined by the cross test to cross the line from the transmission point.

The tracing of the ray may include checking whether a line connecting the receipt point to an end of the valid radio wave blocking obstacle surface crosses another radio wave blocking obstacle surface, designating an area around a midpoint of the radio wave blocking obstacle surface crossing the end of the valid radio wave blocking obstacle surface and an cross point as an interest area, performing a cross test on each of a plurality of segments forming the designated interest area to check whether the line from the receipt point crosses a normal vector of a segment midpoint, and generating a reflection ray tube for the segments which are determined by the cross test to cross the line from the receipt point.

The tracing of the ray may include checking whether a line connecting an image point to an end of a valid radio wave blocking obstacle surface crosses another radio wave blocking obstacle surface, designating an area around a midpoint of the another radio wave blocking obstacle surface crossing the line and the cross point as an interest area, performing a cross test on each of a plurality of segments forming the designated interest area to check whether a line from the image point crosses a normal vector of a segment midpoint, and generating a reflection ray tube for segments which are determined by the cross test to cross the line from the image point.

Additional features of the invention will be set forth in the description which follows, and in part will be apparent from the description, or may be learned by practice of the invention.

### Advantageous Effects

According to the present invention, a radio wave propagation environment is predicted while varying a transmission point and a receipt point, and a simulation speed is improved by an efficient simulation.

Also, when a location of a transmission point dynamically varies, a forward path from the transmission point to a receipt point is traced and then a backward path is traced. When a location of the receipt point dynamically varies, a forward path from the receipt point to the transmission point is traced and then a backward path is traced. Through the forward and backward path tracing, a reflection expansion error is removed and the accuracy of radio wave propagation prediction is increased.

Furthermore, a patch-adaptive discrete search method is used to discard a reflection shrinkage error to enhance the accuracy of radio wave propagation prediction.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an illustration for explaining a reflection shrinkage error.

FIG. 2 is an illustration for explaining a reflection expansion error.

FIG. 3 is a flowchart of a ray tracing method for radio wave propagation prediction according to an exemplary embodiment.

FIG. 4 is an illustration for explaining a ray-tracing when a transmission point is fixed and a receipt point is variable.

FIG. 5 is an illustration for explaining a ray-tracing when a transmission point is variable and a receipt point is fixed.

FIG. 6 is an illustration for explaining a patch discrete search method.

FIG. 7 is an illustration for explaining a patch-adaptive discrete search method according to an exemplary embodiment.

FIG. 8 is a flowchart of preprocessing in operation S110 in FIG. 3.

FIG. 9 is an illustration for explaining how to determine the maximum value and minimum values of coordinates of the corresponding patch in the preprocessing.

FIG. 10 is an illustration showing divided regions of a spherical object.

FIG. 11 is an example of a table showing results of mapping corresponding patches on divided regions of a sphere based on the reference patch.

### MODE FOR THE INVENTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions are omitted to increase clarity and conciseness.

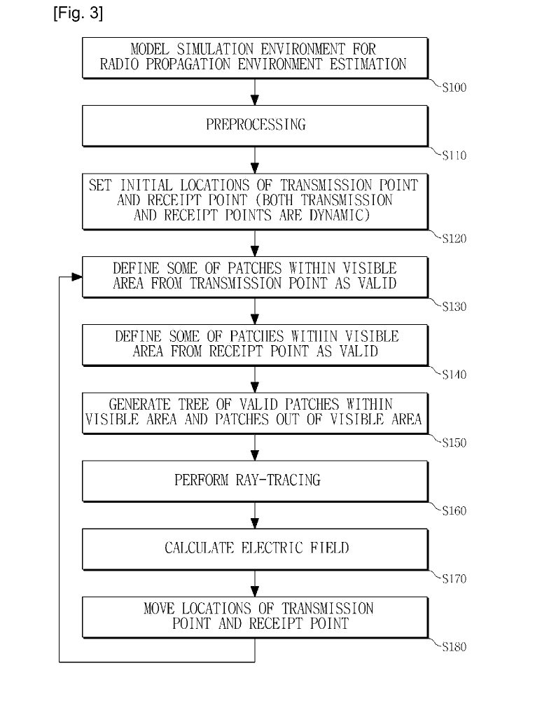

FIG. 3 is a flowchart of a ray tracing method for radio wave propagation prediction according to an exemplary embodiment.

A simulation for ray tracing is performed by an electric device such as a computer. Information required for the radio wave propagation prediction is received. Here, the information for the radio wave propagation prediction is the information on specific objects, such as buildings or terrain features which may block radio wave propagation in a particular area. Additionally, indoor obstacles for the radio wave propagation include furniture such as chairs, desks, or partitions. When a radio wave propagation environment at a certain outdoor area is predicted, image data photographed by a satellite can be used as input information. When information on the radio wave blocking obstacles is input, a virtual three-dimensional (3D) model is modeled according to the input information (operation S100). After the virtual 3D environment is modeled, preprocessing is performed (operation S110). The preprocessing is to leave out some items from the radio wave blocking obstacles based on specific condition to reduce simulation time. The preprocessing is an optional operation.

After preprocessing, an initial location of a transmission point and an initial location of a receipt point are set (operation S120). For reference, terms, a first point and a second point, in the present specification refer to each of a transmission point and a receipt point. According to an exemplary embodiment of the present invention, when setting the initial positions of the transmission and receipt points, at least one of the transmission and the receipt points is set to be dynamic, that is, one of the points is set to change in real time. When the initial positions of the transmission and the receipt points are set, simulation for ray tracing is performed.

Simulation for ray tracing in accordance with an exemplary embodiment of the present invention is performed by following operations. First, at least a part of radio wave propagation obstacle surfaces (hereinafter, referred to as “patches”) within a visible region based on the transmission point are defined as valid radio wave propagation obstacle surfaces (hereinafter, referred to as “valid patches”) (operation S130). According to the present exemplary embodiment, operation S130 is divided into two sub-operations, in each of which a visible region is defined and the valid patches are defined. More specifically, an area within a given distance around the transmission point is defined as a visible region. In one exemplary embodiment, at the transmission point, a cross test is performed on each patch. As known well, the cross test is to confirm if a straight line crosses a normal vector of a surface, and, in this case, to test if a straight line from the transmission point crosses a normal vector of a patch. A distance between the farthest patch from the transmission point, from among the patches which have been confirmed to cross the transmission point by the cross test, is referred to as the maximum visible distance, and the area within the maximum visible distance in all directions from the transmission point is set to be the visible region.

Once the visible region has been set, in consideration of antenna pattern characteristics of the transmission point, from among the patches within the visible region, only the patches belonging to the area within a beam bandwidth related to the antenna characteristic are defined as valid patches. For example, if an antenna is a directional antenna, the corresponding half power beam width (HPBW) is set to be the maximum visible angle, and the patches within the maximum visible angle are defined as valid patches.

According to an exemplary embodiment of the present invention, at least a part of patches included in a visible region around the transmission point are defined as valid patches (operation S140). Operation S140 may be divided into two sub operations, in each of which the visible region is established and the valid patches are defined, and description of each operation is the same as the above.

Once the valid patches have been defined, a tree is generated using the valid patches within the visible region and the patches out of the visible region (operation S150). When preprocessing has been performed, a tree including the visible region and a non-visible region is generated with reference to database of preprocessing results. When the tree is generated, ray tracing is performed (operation S160). In the course of ray-tracing, if the transmission point is dynamic, forward ray-tracing from the transmission point to the receipt point is performed, and afterwards backward ray-tracing is performed to increase the accuracy of simulation. If both the transmission point and the receipt point are dynamic, the forward ray-tracing and the backward ray-tracing are performed, starting from the transmission point, and also the forward and backward ray-tracings are performed, starting from the receipt point.

During the forward and backward ray-tracings, cross tests are performed on patches, which are tree nodes, to generate a ray tube, and radio transmission between the transmission point and the receipt point is traced along the ray tube. If a straight line from an image point does not interfere with a midpoint of a given patch, a patch-adaptive discrete search method, which will be described later, is implemented to prevent reflection shrinkage error, and then the cross tests are performed on a part of the patch. Once the ray-tracing has been complete, an electric field of the entire path of a ray tube between the transmission point and the receipt point is calculated to analyze the radio wave propagation characteristics (operation S170). Then the locations of the transmission point and the receipt point are arbitrarily changed (operation S180), and the processing returns to operation S130 to repeat perform the ray tracing.

The reason for defining the valid patches in operation S130 and S140 in FIG. 3 is that simulation time substantially increases when performing ray-tracing on all patches to be simulated. Especially, when a city area where buildings are densely located is to be simulated, the simulation time will increase and the simulation will take more time if either or both of a transmission point and a receipt point are dynamic Hence, a method is required, which can reduce the simulation time without substantially affecting the simulation result, and in connection with the method, valid patches are defined within a visible region and the other patches which have not been defined as valid are not taken into account for the simulation. Especially, in the exemplary embodiment, since the valid patches are defined in consideration of antenna pattern characteristics, the simulation result does not change significantly even when the other patches that are not defined as valid are not simulated. The ineffectiveness of the non-defined patches to the simulation result can be fully proved by results accumulated from the numerous conventional ray-tracing simulations.

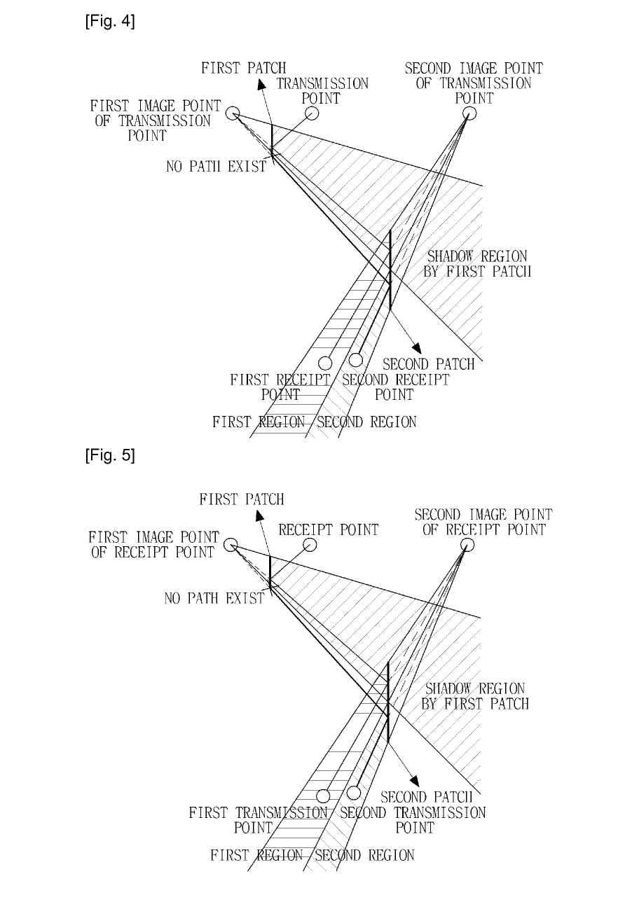

FIG. 4 is an illustration for explaining a ray-tracing when a transmission point is fixed and a receipt point is variable.

In this case, when forward ray tracing is performed, a first region and a second region are belonging to a receivable area. Therefore, it is analyzed that a first receipt point and a second receipt point are possible to receive ray radiation from a transmission point. However, in practice, the first region is not a ready-for-receiving area and this phenomenon is referred to as a reflection expansion error. To avoid the reflection expansion error, in the current exemplary embodiment, backward ray tracing is performed instead of forward ray tracing when the transmission point is fixed and the receipt point is variable. As the result of the backward ray tracing, ray-tracing takes place along a path from the second receipt point to the transmission point, but it is analyzed that there is no existing path from the first receipt point to the transmission point. Hence, in the case of the fixed transmission point and variable receipt points, the reflection expansion error can be prevented by backward ray tracing.

FIG. 5 is an illustration for explaining a ray-tracing when a transmission point is variable and a receipt point is fixed.

In forward ray tracing, it is analyzed that ray tracing is performed along a path from a second transmission point to the receipt point. However, it is analyzed that a path from a second transmission point to the receipt point is not traced. That is, a second region is not analyzed as valid for radio wave propagation path, and a first region is analyzed as invalid. Contrarily, in the case of backward ray tracing from the transmission point to the receipt point, since both the first and second regions are analyzed as receivable, reflection expansion error may occur. Accordingly, in the current exemplary embodiment, only the forward ray tracing is performed instead of the backward ray tracing when the transmission point is variable and the receipt point is fixed. As such, when forward ray tracing is performed under the condition where a transmission point is variable and a receipt point is fixed, the reflection expansion error can be improved.

Consequently, in a dynamic radio wave propagation environment in accordance with the exemplary embodiment, a 3D ray tracing method performs both forward and backward ray tracings. Through these tracings, reflection expansion error can be avoided.

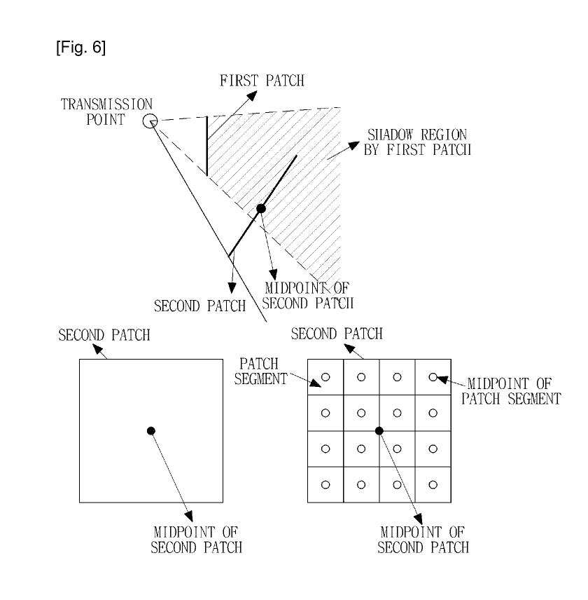

FIG. 6 is an illustration for explaining a patch discrete search method.

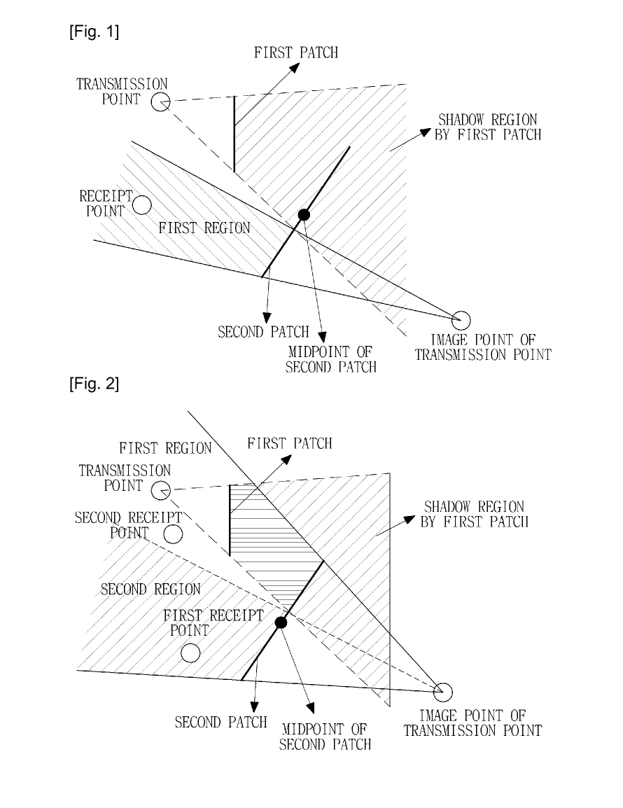

The patch discrete search method will be described with reference to FIG. 1 together with FIG. 6. FIG. 1 is an illustration showing a case where a midpoint of a second patch is not seen due to a first patch placed over the point. In this case, the conventional ray tube tracing method causes reflection expansion error. In other words, it is determined that the whole area of the second patch does not reflect rays radiated from the transmission point at all despite of the fact that some part of the second patch reflects the rays. To overcome such problems, in the patch discrete search method, the second patch is divided into a plurality of segments, each of which has a midpoint. Then, instead of performing a cross test on a midpoint of the second patch, each cross test is performed on the midpoint of each segment. Accordingly, reflected ray tubes are formed by some of the segments of the second patch. As the result, reflection shrinkage error can be improved.

However, the patch discrete search method in FIG. 6 divides each patch into a plurality of segments, and performs cross tests for individual midpoints of all segments, and thus it takes too much time for simulation. As mentioned above, the simulation time is crucial to ray tracing for ray propagation prediction. Hence, the patch discrete search method in FIG. 6 is not suitable for the dynamic radio wave propagation environment like in the exemplary embodiment.

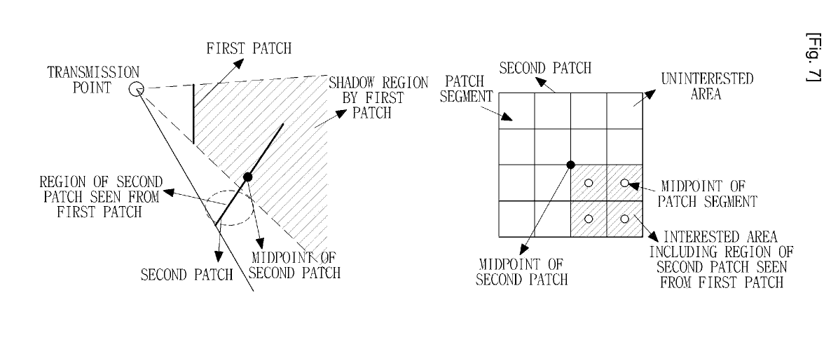

FIG. 7 is an illustration for explaining a patch-adaptive discrete search method according to an exemplary embodiment. This method is for overcoming a disadvantage of prolonged simulation time in the patch discrete search method in FIG. 6.

First, a midpoint of the second patch is detected. Since patch's midpoint data is previously stored in database, the midpoint of the second patch can be searched in the database. Then, it is checked if a line connecting between a transmission point and an end of a first patch is crossing the second patch. Although the transmission point is one end of the line in FIG. 7, a receipt point or an image point may be connected to the end of the first patch according to the position of an intended patch. When the line and the second patch cross each other, an interest area is set by calculating an area of the second patch which is viewed from the first patch. Then, cross tests are, respectively, performed on midpoints of a plurality of segments included in the interest area.

By the patch-adaptive discrete search method in accordance with the exemplary embodiment, cross tests do not have to be performed on midpoints of each segment. In addition, a part of a patch is checked if a reflection tube can be formed thereon, and the cross tests are performed on only the segments included in the corresponding part of the patch. As the result, simulation time and reflection shrinkage error can be reduced. The patch-adaptive patch discrete search method in accordance with the exemplary embodiment may be employed in ray-tracing and also in setting a visible region.

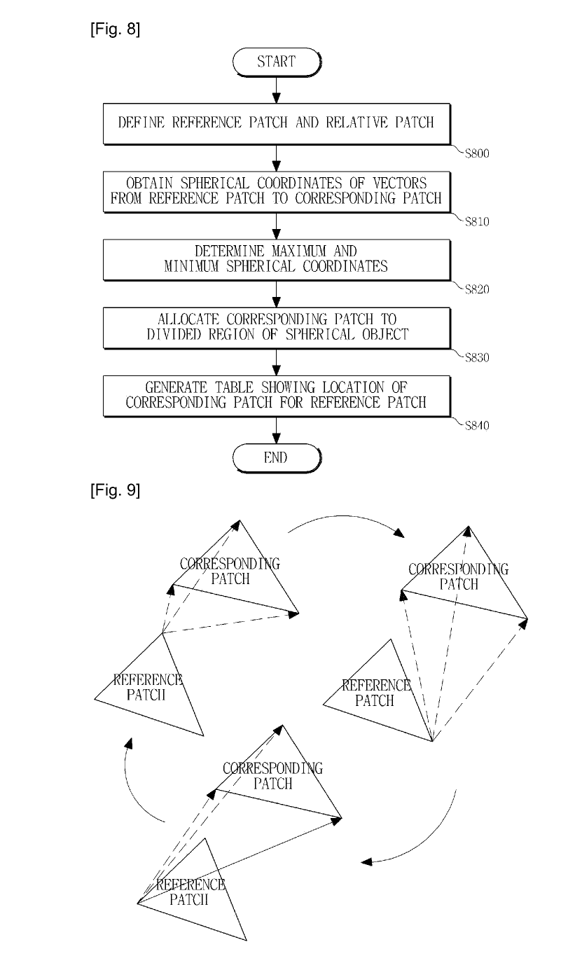

FIG. 8 is a flowchart of preprocessing in operation 5110 in FIG. 3.

First, a reference patch and a corresponding patch are defined (operation S800). The reference patch refers to a surface of a certain radio wave blocking obstacle for light incident thereto, and the corresponding patch refers to a surface of another radio wave blocking obstacle which the light reflected or diffracted from the reference patch secondarily reaches. Once the reference patch and the corresponding patch have been defined, coordinates of vectors from the reference patch to the corresponding patch are obtained (operation S810). More specifically, a vector from a vertex of the reference patch to a vertex of the corresponding patch is defined in a rectangular coordinate system, and then the defined vector is converted into spherical coordinates (θ, φ).

For example, as shown in FIG. 9, if the reference patch and the corresponding patch are triangle, vectors from a first vertex of the reference patch to each vertex of the corresponding patch are defined, and each defined vector is converted into spherical coordinates (θ, φ). Subsequently, the spherical coordinates (θ, φ) of vectors from each of a second vertex and a third vertex of the reference patch to each vertex of the corresponding patch are obtained. Then, the maximum and the minimum values of spherical coordinates of the vector are determined by comparing nine spherical coordinates of the vectors (operation S820). The determined maximum and minimum values of coordinates define a range with which light reflected or diffracted from the reference patch can proceed to the corresponding patch. In operation 5820, the maximum and minimum values of coordinates of each of corresponding patches for one reference patch are determined.

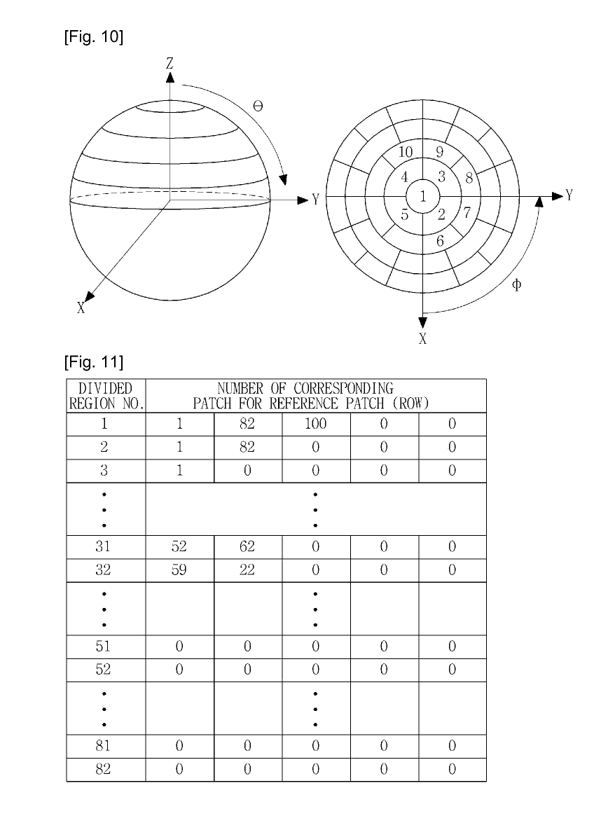

The corresponding patches are allocated to divided regions of a spherical object (operation S830). With reference to FIG. 10, the spherical object is divided by elevations (θ) and azimuths (φ) into m regions (m is a natural number). Then, if the maximum and minimum values of coordinates of corresponding patches are included within one of m divided regions, the corresponding patches are allocated to the region. In this case, it is assumed that the reference patch is placed at the center of the sphere. After all of the corresponding patches are allocated, a mapping table is generated which indicates the position of each corresponding patch on the divided regions of the sphere based on the reference patch (operation S840).

FIG. 11 is an example of a table showing results of mapping corresponding patches on divided regions of a sphere based on the reference patch.

A first column of the mapping table indicates a serial number of a divided region of the sphere, and the sphere may have, for example, 82 divided regions. Each of a second to sixth columns of the sphere indicates the number of the corresponding patch allocated to each divided region of the sphere. More specifically, the second column shows that No. 1 corresponding patches are allocated from the first through third divided regions, a No. 52 corresponding patch is allocated to a thirty first divided region and a No. 59 corresponding patch is allocated to a thirty second divided region with respect to the first reference patch. In addition, it is shown that there are no allocated corresponding patches on fifty-first and fifty-second divided regions and eighty first and eighty second divided regions. Moreover, a third column of the mapping table shows that with respect to the second reference patch, No. 82 corresponding patches are allocated from the first and second divided regions, a No. 62 corresponding patch is allocated to a thirty first divided region and a No. 22 corresponding patch is allocated to a thirty second divided region.

Only once performance of the above-described preprocessing method may generate a satisfactory result regardless of the changes in locations of the transmission point or the receipt point. Therefore, the preprocessing does not have to be performed whenever the locations of the transmission point and the receipt point, thereby increasing the simulation time.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. The media may also be a transmission medium such as optical or metallic lines, wave guides, and the like including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations and methods described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of tracing three dimensional ray in a dynamic radio wave propagation environment, by which cross tests are performed on a plurality of radio wave blocking obstacle surfaces according to a ray tube tracing scheme based on an image method in a simulation area, in which the plurality of radio wave blocking obstacle surfaces are modeled, to detect a radio path between a first point and a second point, the method comprising:
defining at least a part of the radio wave blocking obstacle surfaces as valid radio wave blocking obstacle surfaces, the radio wave blocking obstacle surfaces being within a visible region from the first point of which location varies dynamically; and
tracing a ray between the first point and the second point by taking into consideration only the defined valid radio wave blocking obstacle surfaces to be simulated.

2. The method of claim 1, wherein the defining of the valid radio wave blocking obstacle surfaces includes establishing a visible region starting from the first point and defining the radio wave blocking obstacle surfaces within a predetermined angle from the first point in the visible region as valid radio wave blocking obstacle surfaces.

3. The method of claim 2, wherein in the establishing of the visible region, a region within a predetermined distance from the first point in all directions is established as the visible region.

4. The method of claim 2, wherein in the defining of the part of the radio wave blocking obstacle surfaces within the predetermined angle from the first point as the valid radio wave blocking obstacle surfaces, the radio wave blocking obstacle surfaces within a corresponding beam width are defined as the valid radio wave blocking obstacle surfaces according to an antenna pattern characteristic at the first point.

5. The method of claim 1, wherein the tracing of the ray includes tracing a ray starting from the first point to the second point and tracing a ray starting from the second point to the first point.

6. The method of claim 1, wherein the tracing of the ray includes checking whether a line connecting the first point to an end of the valid radio wave blocking obstacle surface crosses another radio wave blocking obstacle surface, designating an area around a midpoint of the radio wave blocking obstacle surface crossing the end of the valid radio wave blocking obstacle surface and an cross point as an interest area, performing a cross test on each of a plurality of segments forming the designated interest area to check whether the line from the first point crosses a normal vector of a segment midpoint, and generating a reflection ray tube for the segments which are determined by the cross test to cross the line from the first point.

7. The method of claim 6, wherein the checking of whether the line connecting the first point to the end of the valid radio wave blocking obstacle surface crosses the another radio wave blocking obstacle surface is performed only when it is determined as the result of the cross test that the first point and the another radio wave blocking obstacle surface do not cross each other.

8. The method of claim 1, wherein the tracing of the ray includes checking whether a line connecting the second point to a valid radio blocking obstacle surface crosses another radio wave blocking obstacle surface, designating an area around a midpoint of the another radio wave blocking obstacle surface and the cross point as an interest area, and performing a cross test on each of a plurality of segments forming the designated interest area to check whether the line from the second line crosses a normal vector of a segment midpoint, and generating reflecting ray tubes for segments which are determined by the cross test to cross the line from the first point.

9. The method of claim 1, wherein the checking of whether the line connecting the second point to the end of the valid radio wave blocking obstacle surface crosses another radio wave blocking obstacle surface is performed only when it is determined as the result of the cross test that the second point and the another radio wave blocking obstacle surface do not cross each other.

10. The method of claim 1, wherein the tracing of the ray includes checking whether a line connecting an image point to an end of a valid radio wave blocking obstacle surface crosses another radio wave blocking obstacle surface, designating an area around a midpoint of the another radio wave blocking obstacle surface crossing the line and the cross point as an interest area, performing a cross test on each of a plurality of segments forming the designated interest area to check whether a line from the image point crosses a normal vector of a segment midpoint, and generating a reflection ray tube for segments which are determined by the cross test to cross the line from the image point.

11. The method of claim 10, wherein the checking if whether the line connecting the image point to the end of the valid radio wave blocking obstacle surface crosses another radio wave blocking obstacle surface is performed only when it is determined as the result of the cross test that the image point and the another radio wave blocking obstacle surface do not cross each other.

12. A method of tracing a three dimensional ray in a dynamic wave propagation environment, by which cross tests are performed on a plurality of radio wave blocking obstacle surfaces according to a ray tube tracing scheme based on an image method in a simulation area, in which the plurality of radio wave blocking obstacle surfaces are modeled, to detect a radio path between a transmission point and a receipt point, the method comprising:
defining at least a part of the radio wave blocking obstacle surfaces as valid radio wave blocking obstacle surfaces, the radio wave blocking obstacle surfaces being within a visible region from the transmission point of which location varies dynamically;
defining at least a part of the radio wave blocking obstacle surfaces as valid radio wave blocking obstacle surfaces, the radio wave blocking obstacle surfaces being within a visible region from the receipt point of which location varies dynamically;
tracing a ray between the transmission point and the receipt point by taking into consideration only the defined valid radio wave blocking obstacle surfaces to be simulated.

13. The method of claim 12, wherein the defining of at least the part of the radio wave blocking obstacle surfaces within a visible region from the transmission point as the valid radio wave blocking obstacle surfaces includes establishing a visible region starting from the transmission point and defining the radio wave blocking obstacle surfaces within a predetermined angle from the transmission point in the visible region as valid radio wave blocking obstacle surfaces.

14. The method of claim 13, wherein in the establishing of the visible region, a region within a predetermined distance from the transmission point in all directions is established as the visible region.

15. The method of claim 13, wherein in the defining of the part of the radio wave blocking obstacle surfaces within the predetermined angle from the transmission point as the valid radio wave blocking obstacle surfaces, the radio wave blocking obstacle surfaces within a corresponding beam width are defined as the valid radio wave blocking obstacle surfaces according to an antenna pattern characteristic at the transmission point.

16. The method of claim 12, wherein the defining of at least the part of the radio wave blocking obstacle surfaces within a visible region from the receipt point as the valid radio wave blocking obstacle surfaces includes establishing a visible region starting from the receipt point and defining the radio wave blocking obstacle surfaces within a predetermined angle from the receipt point in the visible region as valid radio wave blocking obstacle surfaces.

17. (canceled)

18. The method of claim 16, wherein in the defining of the part of the radio wave blocking obstacle surfaces within the predetermined angle from the receipt point as the valid radio wave blocking obstacle surfaces, the radio wave blocking obstacle surfaces within a corresponding beam width are defined as the valid radio wave blocking obstacle surfaces according to an antenna pattern characteristic at the receipt point.

19. The method of claim 12, wherein the tracking of the ray includes checking whether a line connecting the transmission point to an end of the valid radio wave blocking obstacle surface crosses another radio wave blocking obstacle surface, designating an area around a midpoint of the radio wave blocking obstacle surface crossing the end of the valid radio wave blocking obstacle surface and an cross point as an interest area, performing a cross test on each of a plurality of segments forming the designated interest area to check whether the line from the transmission point crosses a normal vector of a segment midpoint, and generating a reflection ray tube for the segments which are determined by the cross test to cross the line from the transmission point.

20. (canceled)

21. The method of claim 12, wherein the tracing of the ray includes checking whether a line connecting the receipt point to an end of the valid radio wave blocking obstacle surface crosses another radio wave blocking obstacle surface, designating an area around a midpoint of the radio wave blocking obstacle surface crossing the end of the valid radio wave blocking obstacle surface and an cross point as an interest area, performing a cross test on each of a plurality of segments forming the designated interest area to check whether the line from the receipt point crosses a normal vector of a segment midpoint, and generating a reflection ray tube for the segments which are determined by the cross test to cross the line from the receipt point.

22. (canceled)

23. The method of claim 12, wherein the tracing of the ray includes checking whether a line connecting an image point to an end of a valid radio wave blocking obstacle surface crosses another radio wave blocking obstacle surface, designating an area around a midpoint of the another radio wave blocking obstacle surface crossing the line and the cross point as an interest area, performing a cross test on each of a plurality of segments forming the designated interest area to check whether a line from the image point crosses a normal vector of a segment midpoint, and generating a reflection ray tube for segments which are determined by the cross test to cross the line from the image point.

24. (canceled)
